(19) United States
(12) Patent Application Publication
(10) Pub. No.: US 2007/0297439 A1
(43) Pub. Date: Dec. 27, 2007

(54) Selection of an access layer termination node in a multi-access network environment

(75) Inventor: Jari Ihattula, Santa Clara, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/808,249

(22) Filed: Jun. 7, 2007

Related U.S. Application Data
(60) Provisional application No. 60/814,526, filed on Jun. 19, 2006.

(51) Int. Cl. H04L 12/413

(52) U.S. Cl. 370/445

(57) ABSTRACT

In a mechanism to select an access layer termination node for a communication connection of a user terminal in a multi-access network, a connection parameter list is transmitted in a mobile IP registration procedure from a mobility layer network portion to a user terminal. The connection parameter list comprises prioritized information on connection parameters of an access layer. The prioritized information is then used for selecting an access layer network portion when establishing a connection between the user terminal and a network comprising the access layer network portion.

### CROSS REFERENCE TO RELATED APPLICATIONS

This application claims priority of U.S. Provisional Patent Application Ser. No. 60/814,526, filed Jun. 19, 2006. The disclosure of the prior application is hereby incorporated by reference herein in its entirety.

### BACKGROUND OF THE INVENTION

1. Field of the Invention

The present invention relates to a mechanism to select an access layer termination node for a communication connection of a user terminal in a multi-access network. The invention relates in particular to an improved method, network nodes, system, and computer program product usable for selecting a suitable access node in a multi-access network environment using Mobile Internet Protocol (mobile IP or MIP).

For the purpose of the present invention to be described herein below, it should be noted that

a user terminal may for example be any device by means of which a user may access a communication network; this implies mobile as well as non-mobile devices and networks, independent of the technology platform on which they are based; only as an example, it is noted that communication equipments operated according to several communication techniques, such as principles standardized by the 3^{rd} Generation Partnership Project 3GPP and known for example as UMTS terminals, Wireless Local Area Network (WLAN) terminals and the like, are particularly suitable for being used in connection with the present invention;

message or signalling used in the present invention may be of different type and have different contents; content as used in the present invention is intended to mean also multimedia data of at least one of audio data, video data, image data, text data, and meta data descriptive of attributes of the audio, video, image and/or text data, any combination thereof or even, alternatively or additionally, other data such as, as a further example, program code of an application program to be accessed/downloaded;

method steps likely to be implemented as software code portions and being run using a processor at one of the entities described herein below are software code independent and can be specified using any known or future developed programming language;

method steps and/or devices likely to be implemented as hardware components at one of the entities are hardware independent and can be implemented using any known or future developed hardware technology or any hybrids of these, such as MOS, CMOS, BiCMOS, ECL, TTL, etc, using for example ASIC components or DSP components, as an example;

generally, any method step is suitable to be implemented as software or by hardware without changing the idea of the present invention;

devices or means can be implemented as individual devices or means, but this does not exclude that they are implemented in a distributed fashion throughout the system, as long as the functionality of the device is preserved.

2. Related Prior Art

In the last years, an increasingly extension of communication networks, e.g. of wire based communication networks, such as the Integrated Services Digital Network (ISDN), or wireless communication networks, such as the cdma2000 (code division multiple access) system, cellular 3rd generation (3G) communication networks like the Universal Mobile Telecommunications System (UMTS), cellular 2nd generation (2G) communication networks like the Global System for Mobile communications (GSM), the General Packet Radio System (GPRS), the Enhanced Data Rates for Global Evolutions (EDGE), or other wireless communication system, such as the Wireless Local Area Network (WLAN), took place all over the world. Various organizations, such as the 3^{rd} Generation Partnership Project (3GPP), the International Telecommunication Union (ITU), 3^{rd} Generation Partnership Project 2 (3GPP2), Internet Engineering Task Force (IETF), and the like are working on standards for telecommunication network and multiple access environments.

In general, the system structure of a communication network is such that one party, e.g. a subscriber's communication equipment, such as a mobile station, a mobile phone, a fixed phone, a personal computer (PC), a laptop, a personal digital assistant (PDA) or the like, is connected via transceivers and interfaces, such as an air interface, a wired interface or the like, to an access network subsystem. The access network subsystem controls the communication connection to and from the communication equipment and is connected via an interface to a corresponding core or backbone network subsystem. The core (or backbone) network subsystem switches the data transmitted via the communication connection to a destination party, such as another communication equipment, a service provider (server/proxy), or another communication network. The access network subsystem may also provide a connection to an IP based network, such as the Internet, by means of specific gateways. It is to be noted that the core network subsystem may be connected to a plurality of access network subsystems. Depending on the used communication network, the actual network structure may vary, as known for those skilled in the art and defined in respective specifications, for example, for UMTS, GSM and the like.

Generally, for properly establishing and handling a communication connection between network elements such as the user terminal (or subscriber terminal) and another communication equipment or terminal, a database, a server, etc., one or more intermediate network elements, such as network control elements, support nodes or service nodes are involved. Network control elements, such as a Mobile Switching Center (MSC), a Serving GPRS Support Node (SGSN), a Gateway GPRS Support Node (GGSN), a Packet Data Gateway (PDG) or the like, are responsible for controlling the call establishment, call control, call termination, and the like.

Since more and more communication network systems, such as circuit switched (CS) networks, packet switched (PS) networks, Internet Protocol (IP) based networks and the like are established in parallel, the provision of systems and elements providing access to more than one network system for a user terminal are developed. Such multi-access networks allow a connection to data services from multiple access technologies such as GSM, WCDMA, WLAN and Wimax. All these different access technologies require different kind of access termination functionality, which can be implemented in one or many network elements. Charging and QoS are often dependent on the access technology. When a seamless service continuity is implemented by adding a mobility layer on top of the access termination layer there will be a need to convey the access specific information between the mobility and access termination layer.

The implementation of the mobility layer can be a Mobile IP Home Agent that acts as an anchor point for the user sessions. A Home Agent (HA) is a router on the home network of the user terminal (or mobile node) which forwards data packets to the user terminal. The user terminal is assigned a permanent address (home address) and a temporary address called Care-of address (CoA) when moving. The user terminal informs the HA about the CoA by means of a registration procedure so that the HA can follow the user terminal in the network.

In a multi-access network mobility layer and an access termination layer (or access layer) work independently. It is also possible that the access termination layer is not even aware about the existence of the mobility layer in a multi-access environment. Both an access termination point and a mobility anchor point can be freely selected based only on the information on their respective layers.

Conventionally, the network element terminating the access is selected using some access specific method. For example, a Domain Name System (DNS) query is used to resolve the IP address of the serving access termination node. A DNS server can include some load balancing algorithm to select the serving node from a pool of nodes. However, when for example a handover to a different access technology is done it is possible that again a different node can be selected for the access termination. Hence, it is not possible to make sure that the access is terminated always in the same node where the mobile IP home agent is located.

The allocation of the mobility anchor point can be also dynamic based on many parameters.

It is even possible that the mobility services are provided by a different operator than the access service. In this case the selection of the mobility anchor point (i.e. of a Home Agent) is managed also by a different operator than the access network

This means that even though decoupling of access and mobility layers provides a great amount of flexibility, there are caused some problems in certain situations.

Generally, a selection of an access gateway may be based on different factors, such as operator, usable or available access technology and location of the user terminal. Due to the decoupling of the mobility layer from the access layer, the services that are behind the mobility anchor point cannot affect the selection of the access gateway unless the terminal has enough knowledge to make that selection. This in turn can depend on the service provider's policies which may also change over time or depend on the location of the user or the access technologies available. Currently, a transfer of access gateway selection policies to the user terminal is not readily possible for a service provider hosting the mobility anchor point.

In the following, examples for illustrating the problem associated with a selection of an access termination node in a multi-access environment, which are caused by the decoupling of the access termination and mobility layer, are described in connection with FIGS. 7 and 8.

In FIG. 7, a network architecture is shown by means of which a first example for a problem associated with the establishment of a communication connection in a multi-access environment is described. In FIG. 7, reference sign 310 denotes a mobile node or user terminal. Reference signs 320 and 330 denote access gateways such as a PDG or a GGSN which represent an access termination node for a connection of the user terminal 310 via respective access provider sites 325 and 335. Reference sign 60 denotes an IP based network via which a connection to a service provider can be established. At Service Provider Sites 345, 355 Home Agents HA1 340 and HA2 350 are provided. It is to be noted that the Service Provider Sites may comprise several other entities, such as an AAA (authentication, authorization, accounting) entity, an application server and the like, which are known to those skilled in the art and therefore not shown here for the sake of simplicity.

Basically, the selection of a Mobile Home Agent may be based on many parameters, which due to the decoupling of the access termination and the mobility layer are not known by the access termination layer. Before connecting to the Home Agent a connection must be established between the user terminal and the access termination point, i.e. an Access Gateway (AGW). This Access Gateway can be e.g. a GGSN or PDG depending on the access technology used.

Because of the decoupling between the access termination layer and the mobility layer, there may be a situation where the selected Access Gateway is not optimal for the Home Agent selected. In the example shown in FIG. 7, it is assumed that the user terminal 310 is configured to use the AGW1 320 (which is, for example, a PDG) when connecting to the service provider 1. Furthermore, it is assumed that the Service Provider 1 is providing also the mobility service, i.e. the Home Agent is located in the Service Provider network (HA1).

When the user terminal has moved to a new location (indicated by the arrow on the left side of FIG. 7) and a session is to be started with the service provider 1 the following situation occurs. The user terminal 310 is still configured to connect to the AGW1 320. However, the service provider 1 notices that for the new location the user terminal is better served through a Home Agent HA2 350 in the site 2 of the service provider. Thus, the session is redirected to the HA2 350 in site 2 355 (arrow on the right side of FIG. 7). To get the current location of the user terminal, same mechanisms can be used by the service provider as for location based services (if available), for example, or the location information can be also sent by the user terminal by using, for example, a vendor specific MIP extension defined for this purpose.

Based on the location information, the optimum Access Gateway in this situation would be AGW2 330, which is, for example, another PDG. However, as mentioned above, the user terminal has connected via AGW1 320 for which it is configured. There is no mechanism available to get the connection redirected to AGW2. Thus, the connection to the HA2 350 is directed via the AGW1 320, as indicated in FIG. 7, which is not optimal for the connection.

It is to be noted that the HA can be also located in the access provider network site. However, also in this case the situation would be the same.

In FIG. 8, another situation is shown where a problem for selecting a suitable access termination node is present. In FIG. 8, a network architecture is shown comprising a mobile node or user terminal 410, AGW1 420 for an access provider 1 site (or access technology 1), AGW2 430 for an access provider 2 site (or access technology 2), an IP network 60, and a service provider 1 site comprising a Home Agent HA1 440. In the example according to FIG. 8, an example is described in which in multi-access environment the optimum path would be in some cases achieved by using, for example, a totally different access provider or using a different kind of access technology. It is assumed that the user terminal 410 is configured to use the AGW1 420 (which is, for example, a GGSN) when connecting to the service provider 1 445. As mentioned above, the service provider 1 445 is providing also the mobility service, i.e. the Home Agent HA1 440 is located in the Service Provider network.

Similar to the example shown in FIG. 7, the user terminal has initially connected via the AGW1 420 to the service provider 1 445 (HA1 440) and moves then to a new location (left arrow in FIG. 8). At the new location, it is noticed that there are new operator networks and/or new access technologies available, i.e. access network 2 435 and AGW2, which is, for example, a PDG. However, the user terminal 410 is still configured to connect to the AGW1 420. The service provider 1 445 notices that for the current location the user is better served through AGW2 430, which is provided by some other access operator or just terminates different access technology. However, there is no mechanism available to get the connection redirected to the AGW2 430, so that the connection to the HA1 would still be via the access provider 1 425 and the AGW1 420.

In the following, another situation is described in which it may be problematic to select the appropriate access termination node. In the FIGS. 7 and 8, there is described mainly a case where the access termination is implemented in a different network element than the mobile IP home agent. In such a case, there is a need for extra signalling between the access termination node and the home agent.

Therefore, development of an architecture took place where the access termination and the home agent are integrated in one network element. This removes the need for extra signalling between the nodes, because the information from the access termination is already available to the home agent when it is located in the same node as the access termination.

However, making sure that the access is always terminated in the same network element where the home agent is located is difficult.

For example, a multi-access network element is provided which has integrated access termination for different access technologies and a mobile IP home agent. For example, a GGSN for GPRS access and a Packet Data Gateway (PDG) for WLAN access is provided in the multi-access network element. A subscriber with multi-access user terminal (i.e. a terminal with both GPRS and WLAN access capabilities) can access to services either through GPRS or WLAN via this multi-access network element with seamless service continuity.

However, when the home agent is dynamically allocated as mentioned above, it is not possible to pre-configure in the user terminal that the access termination is always in the same network element where the mobile IP session is terminated. Thus, it is not possible to ensure that the optimum access termination point is used. For load balancing reasons also the access termination point is dynamically selected. Due to this it is not possible to guarantee that, for example, after a Mobile IP handover the same access termination point would be selected.

### SUMMARY OF THE INVENTION

Thus, it is an object of the invention to provide an improved mechanism for overcoming the above mentioned problems. Furthermore, it is an object of the present invention to provide an improved mechanism enabling an optimized selection of an access termination node in a multi-access environment where the access termination layer and the mobility layer are decoupled.

This object is achieved by the measures defined in the attached claims.

In particular, according to one aspect of the proposed solution, there is provided, for example, a method comprising transmitting in a mobile IP registration procedure a connection parameter list from a mobility layer network portion to a user terminal, wherein the connection parameter list comprises prioritized information on connection parameters of an access layer, using the prioritized information for selecting an access layer network portion when establishing a connection between the user terminal and a network comprising the access layer network portion.

Furthermore, according to one aspect of the proposed solution, there is provided, for example, an apparatus being configured to act as a mobility layer network element for a communication connection of a user terminal via a network, and to transmit in a mobile IP registration procedure a connection parameter list to the user terminal, wherein the connection parameter list comprises prioritized information on connection parameters of an access layer, the prioritized information being usable for selecting an access layer network portion when establishing a connection between the user terminal and a network comprising the access layer network portion.

Moreover, according to one aspect of the proposed solution, there is provided, for example, an apparatus being configured to act as a user terminal capable of communicating in a network, to receive in a mobile IP registration procedure a connection parameter list from a mobility layer network portion, wherein the connection parameter list comprises prioritized information on connection parameters of an access layer, to use the prioritized information for selecting an access layer network portion when establishing a connection between the user terminal and a network comprising the access layer network portion.

In addition, according to one aspect of the proposed solution, there is provided, for example an apparatus being configured to act as an access layer network portion usable for a connection of a user terminal to a network, to intercept a transmission of a connection parameter list from a mobility layer network portion of the network and a user terminal, wherein the connection parameter list comprises prioritized information on connection parameters of an access layer usable for selecting an access layer network portion when establishing a connection between the user terminal and a network comprising the access layer network portion, to supplement the prioritized information with refined information on the access layer available at the apparatus intercepting the transmission, to forward the connection parameter list together with the supplemented refined information to the user terminal.

Furthermore, according to one aspect of the proposed solution, there is provided, for example, a computer program product for a computer, comprising software code portions for making, when said product is run on the computer, said computer to function as a mobility layer network element for a communication connection of a user terminal via a network, wherein the computer program product is configured to execute transmitting in a mobile IP registration procedure a connection parameter list to the user terminal, wherein the connection parameter list comprises prioritized information on connection parameters of an access layer, the prioritized information being usable for selecting an access layer network portion when establishing a connection between the user terminal and a network comprising the access layer network portion.

In addition, according to one aspect of the proposed solution, there is provided, for example, a computer program product for a computer, comprising software code portions for making, when said product is run on the computer, said computer to function as a user terminal capable of communicating in a network, wherein the computer program product is configured to execute receiving in a mobile IP registration procedure a connection parameter list from a mobility layer network portion, wherein the connection parameter list comprises prioritized information on connection parameters of an access layer, using the prioritized information for selecting an access layer network portion when establishing a connection between the user terminal and a network comprising the access layer network portion.

Moreover, according to one aspect of the proposed solution, there is provided, for example, a computer program product for a computer, comprising software code portions for making, when said product is run on the computer, said computer to function as an access layer network portion usable for a connection of a user terminal to a network, wherein the computer program product is configured to execute intercepting a transmission of a connection parameter list from a mobility layer network portion of the network and a user terminal, wherein the connection parameter list comprises prioritized information on connection parameters of an access layer usable for selecting an access layer network portion when establishing a connection between the user terminal and a network comprising the access layer network portion, supplementing the prioritized information with refined information on the access layer available at the apparatus intercepting the transmission, forwarding the connection parameter list together with the supplemented refined information to the user terminal.

Furthermore, according to one aspect of the proposed solution, there is provided, for example, a system comprising a plurality of access layer network portions usable for connecting a user terminal to a network, at least one mobility layer network portion, and a user terminal, wherein the at least one mobility layer network portion is configured to transmit in a mobile IP registration procedure a connection parameter list to the user terminal, wherein the connection parameter list comprises prioritized information on connection parameters of an access layer, and the user terminal is configured to use the prioritized information for selecting an access layer network portion from the plurality of access layer network portions when establishing a connection between the user terminal and the network comprising the access layer network portion.

According to further refinements, the proposed solution may comprise one or more of the following features:

the connection parameter list may be created in the mobility layer network portion;

the connection parameter list may comprise at least one of the following information: information on an access technology and/or a type of network element of the access layer network portion; information on a network address of the access layer network portion; information on an access point name required for a connection to the access layer network portion; an identifier of an operator administering the connection parameter list;

in the mobile IP registration procedure a localized information list may be transmitted from the user terminal to the mobility layer network portion, wherein the localized information list comprises information detected at the location of the user terminal, and the information of the localized information list may be used for creating the connection parameter list;

the localized information list may comprise at least one of the following information: information on an access technology available at the location of the user terminal; information on networks visible to the user terminal at the location; location information of the user terminal;

the connection parameter list may be updated at each mobile IP registration procedure before transmitting the connection parameter list to the user terminal;

when an updated connection parameter list comprising different prioritized information is received, the different prioritized information may be used for selecting an access layer network portion for establishing a connection between the user terminal and the network and the connection with the hitherto access layer network portion may be disconnected;

the localized information list may be updated at each mobile IP registration procedure before transmitting the connection parameter list to the mobility layer network portion;

the transmission of the connection parameter list may be intercepted by a network element between the mobility layer network portion and the user terminal, the prioritized information may be supplemented with refined information on the access layer available at the network element intercepting the transmission, and the connection parameter list together with the supplemented refined information may be forwarded to the user terminal;

the network element intercepting the transmission of the connection parameter list may comprise the access layer network portion;

selecting the access layer network portion may comprise at least one of selecting another access network element and selecting another access technology;

the access layer network portion may comprise an access gateway element of a network and the mobility layer network portion may comprise a home agent.

By virtue of the proposed solutions, the following advantages can be achieved. It is possible to enable dynamic selection of an access provider, access technology and access gateway by a service provider based on various parameters. Furthermore, relocation of a home agent is possible while maintaining optimum access termination. In other words, to fully utilize the benefits of integrated access termination and mobile IP home agent, it is possible to enable to provide the access termination always in the same network element where the mobile IP session is terminated while maintaining existing load balancing and high availability mechanisms. Moreover, handovers are made faster by reducing the signalling between network elements and latencies so that seamless handovers are supported. It is also possible to support access and location awareness without any additional signalling between the access termination and home agent.

The above and still further objects, features and advantages of the invention will become more apparent upon referring to the description and the accompanying drawings.

### BRIEF DESCRIPTION OF THE DRAWINGS

FIG. 1 shows a simplified diagram illustrating a network environment in which a first example of an embodiment of the present invention is used.

FIG. 2 shows a simplified diagram illustrating a network environment in which a second example of the embodiment of the present invention is used.

FIG. 3 shows a simplified diagram illustrating a network environment in which a third example of the embodiment of the present invention is used.

FIG. 4 shows a signalling diagram illustrating an access termination node selection according to the first example of the embodiment of the present invention.

FIG. 5 shows a signalling diagram illustrating an access termination node selection according to the second example of the embodiment of the present invention.

FIG. 6 shows a signalling diagram illustrating an access termination node selection according to the third example of the embodiment of the present invention.

FIG. 7 shows a simplified diagram illustrating a network environment in which a conventional access termination node selection is executed.

FIG. 8 shows a simplified diagram illustrating a network environment in which another conventional access termination node selection is executed.

### DESCRIPTION OF PREFERRED EMBODIMENTS

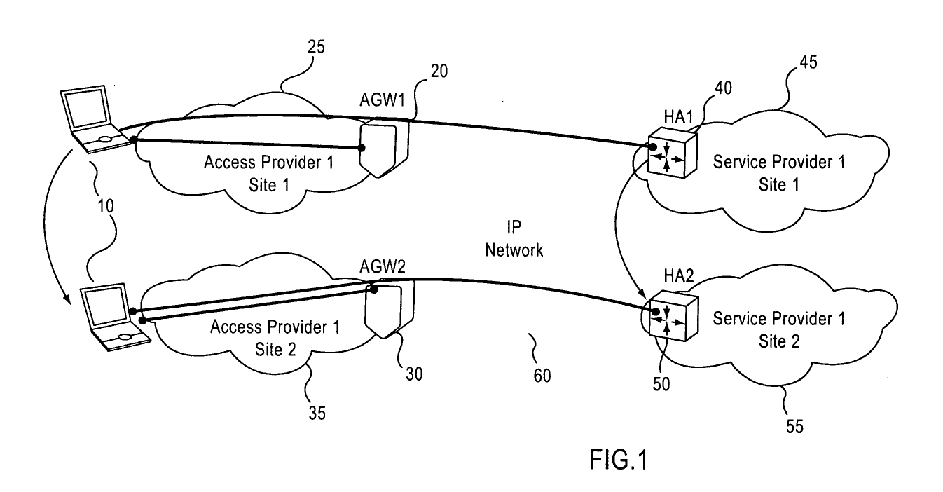

In the following, examples of an embodiment of the present invention are described with reference to the drawings. For illustrating the present invention, the preferred embodiment will be described in a multi-access network environment comprising mobile access network subsystem and core network subsystem components according to the 3GPP specifications as well as Mobile IP components. However, it is to be noted that the present invention is not limited to an application in such network environments but is also generally applicable in other network types, in particular with regard to the type of the access technologies and the network node(s) associated therewith. In FIG. 1, a schematic block diagram of a basic multi-access network environment of a communication network is shown. It is to be noted that the structure according to FIG. 1 represents only a simplified example of an architecture of a communication network environment in which the present invention is applicable. As known by those skilled in the art, there are provided several additional network elements and signaling links used for a communication connection. However, for the sake of simplicity, only those elements are depicted which are necessary for describing the invention.

Furthermore, the network elements and their functions described herein may be implemented by software, e.g. by a computer program product for a computer, or by hardware. In any case, for executing their respective functions, correspondingly used devices, such as a communication equipment, core network control element like a mobile switching centre MSC and associated functions, an access network subsystem element like Radio Access Network RAN element, gateway elements such as GGSN or PDG and the like comprise several means and components (not shown) which are required for control, processing and communication/signaling functionality. Such means may comprise, for example, a processor unit for executing instructions, programs and for processing data, memory means for storing instructions, programs and data, for serving as a work area of the processor and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit (e.g. wired and wireless interface means, an antenna, etc.) and the like.

One important item of the mechanism to select an access layer termination node for a communication connection of a user terminal in a multi-access network is to send by a mobility layer network portion to a user terminal a connection parameter list which includes a prioritized list of information on connection parameters of an access layer, such as addresses and/or other guidance where the connection should be established. The creation of such a list may be based on an algorithm for composing the list of connection parameters whose structure and functions may depend, for example, on the business logic of an operator company utilizing a mechanism according to the present invention. As will become apparent for a person skilled in the art, there are multiple ways how and which input information for such an algorithm can be collected. It is to be noted that the content of the list may comprise different and/or additional information to that described below. The transmission of the connection parameter list is done as a part of a Mobile IP Registration procedure, i.e. as part of the MIP Registration Reply messages by using a new mobile IP extension. The user terminal receiving the connection parameter list is configured to use this information when connecting to an access gateway.

As a further item, a new mobile IP extension can be used by the user terminal to send information regarding the current location to the mobility layer network portion, such as the Home Agent. The Home Agent can use this information when making the decision when creating the prioritized list of connection guidance for the terminal and/or the access provider. In other words, information passed between the user terminal and the mobility anchor point on the mobility layer (the mobility layer network portion) is used to control the access layer.

As described below, the connection parameter list comprising the addresses may include information on the access technology where each address is applicable along with possible other information that may be needed to successfully establish a connection with the access gateway. The list may also include an identifier of the operator administering the list of addresses. The format of the addresses depends on the access technologies used. An address may be e.g. an IP address, a Fully Qualified Domain Name (FQDN), an Access Point name (APN) or any other address format that can be understood as an address by the access network.

Furthermore, the connection parameter list may be updated by the mobility layer network portion in each registration reply. In this case, the user terminal can always follow the latest list. In case there is an existing connection for an access technology where the updated list of addresses proposes a different destination than the existing one, the user terminal should establish a new connection with the recommended access node (or access gateway). Furthermore, the existing connection is to be disconnected from the current access gateway. In case a new access layer network portion (such as a new access gateway) is selected, for example, on the basis of an updated connection parameter list received, a new MIP registration message may be sent by using this new connection. This mechanism effectively introduces a redirection mechanism on the access termination layer guided by the mobility layer.

It is to be noted that this mechanism is also applicable in case only one address is included in the list. In other words, it is possible to manage the access termination node selection with just one address in the list provided the mobility layer network portion knows the used access technology. However, the mechanism is more effective when a list of addresses (i.e. a plurality of addresses) is present because then the user terminal already knows the address of the optimum access gateway before initiating a handover. In case the first (i.e. most preferred) address is not available or reachable by any reason, the next address can be used for connection. If, at a later time, the first address is available again, connection can be switched as in a case of an updated connection parameter list.

It is to be noted that the new Mobile IP extensions that carries the information of the connection parameter list used by the user terminal to establish connections to the optimum access gateways does not have to be originated only by the home gateway. In addition, the information of the connection parameter list can be also added by any other element between the mobility layer network portion (i.e. the home agent) and the user terminal. For example, an intelligent access gateway, such as service aware GGSN or a PDG, may also add a supplement of additional information to the Mobile IP messages. This is typically the case in scenarios where the home agent is administered by a different operator than the access network. In this situation, the access provider is able to provide more refined information on the access gateways to be used, and it is advantageous to provide such information to the user terminal for making the selection of the access layer network portion (access gateway).

In the case that the access layer network portion supplements to the connection parameter list refined information, for example, on the address of the access termination point, the information sent by the mobility layer network element (Home Agent) may be understood as a general guidance on the optimum access termination point, for example with respect to an access technology, operator, or subnet that can then be used by the access gateway and/or the user terminal to determine the optimum addresses. Nested mobile IP extensions carrying the connection parameter list of connection information as described above may be understood as hierarchical information when the information provided by the access provider is a refinement of the information sent by the service provider. In the end the user terminal uses this information to build one prioritized list of addresses.

In multi-access environment it is possible that there are several access providers that can be used for a connection. In this case the access termination information from the home agent to the user terminal can cause the user terminal to select another access provider. The service provider that offers the mobility layer as well as services may also have a list of preferred access providers per access technology. In this case the list of addresses comprised in the connection parameter list simply includes FQDNs that point to different operators.

The mobility layer network element (Home Agent) may use any information available, for example information on a location of the user terminal, when making the decisions on how to construct the list of addresses. This information can be provided by the access provider using any existing method which are known to those skilled in the art. In addition, it is possible to send additional information, i.e. localized information, by the user terminal in a new mobile IP extension. This information may be detected and sent by the user terminal, for example, can be used by the mobility layer network portion and may comprise, for example, access technologies available at the current location, networks available at the current location (this information may include e.g. operator name, network ID, SSID, cell ID etc.), and a location of the terminal, e.g. coordinates, if known.

Preferably, the extensions added by the access layer network portion (access gateway) are authenticated by using a MN (mobile node)-AGW (access gateway) authenticator, which is encoded in the same way as a MN-HA (home agent) authenticator but using a shared secret known by the mobile node (user terminal) and the AGW.

As indicated above, a mechanism to select an access layer termination node for a communication connection of a user terminal in a multi-access network according to the present invention includes a new mobile IP extension. This mobile IP extension can be standardized or vendor specific and is used to send a list of connection parameters to the user terminal which uses them using when connecting to the access networks (i.e. selecting an access layer network portion such as an access gateway). This connection parameter list includes at least one the following information for each entry in the list, but preferably all of the following information:
Access technology (e.g. 2G, 3G, WLAN) and/or type of network element (GGSN, PDG); this is needed to select the correct protocols to use for the connection;
Address of the network element to connect to, such as IP Address or FQDN;
Possible Access Point name needed for the connection, e.g. APN or W-APN;
Operator identifier.

It is to be noted that also other information may be included in the connection list parameter list, if needed.

By means of the information contained in the connection parameter list, the user terminal knows when to use which access termination point and which protocols. It is also possible to use so-called wild cards in the list of addresses in any parameter.

As mentioned above, there can be also used a new mobile IP extension (which may be also new standardized or vendor specific) to send information about the current location (localized information list) of the user terminal to the mobility layer network portion (the Home Agent), wherein this information can be utilized by the Home Agent to determine the optimum list of connection parameters that the user terminal should be using when connecting to the access networks. The localized information list may include at least one of the following information:
Access technology (e.g. 2G, 3G, WLAN) available at the current location;
List of networks visible to the terminal at the current location; this information may include e.g. operator name, network ID, SSID, cell ID etc.
Location of the terminal, e.g. coordinates if known.

The information of the localized information list can be detected or retrieved, for example, by the user terminal by means of methods or mechanisms commonly known to those skilled in the art so that a further description thereof is omitted here.

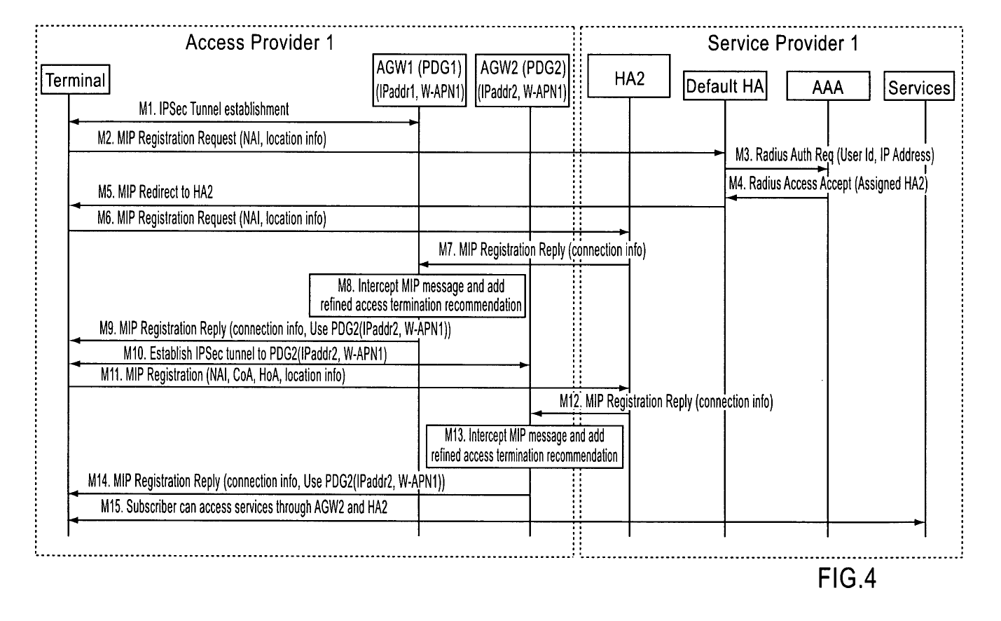

In the following, a first example of an embodiment for the mechanism to select an access layer termination node for a communication connection of a user terminal in a multi-access network is described in connection with FIGS. 1 and 4.

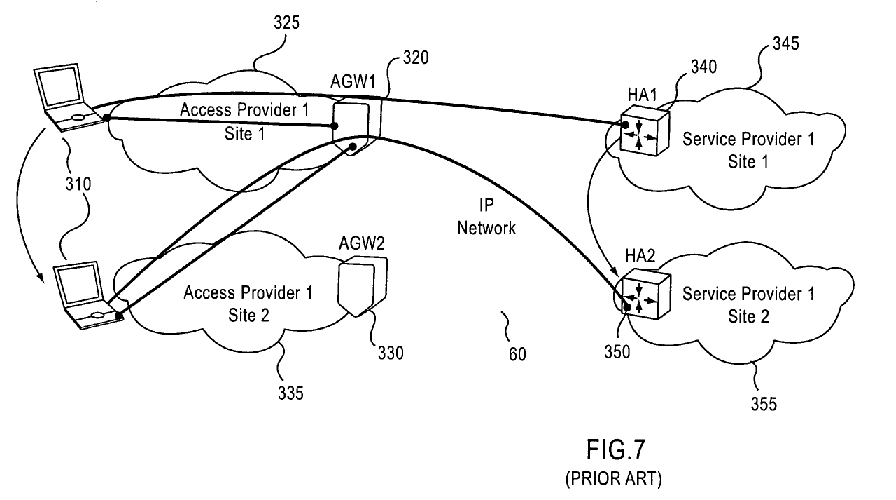

FIG. 1 shows a network architecture and FIG. 4 shows a signaling diagram illustrating an application of the mechanism to select an access layer termination node. The network architecture according to FIG. 1 is similar to that shown in FIG. 7. In FIG. 1, reference sign 10 denotes a mobile node or user terminal. The user terminal 10 may be a single-access or preferably a multi-access terminal. Reference signs 20 and 30 denote access gateways, such as a PDG, a GGSN or the like, which represent an access layer network portion or access termination node for a connection of the user terminal 10 via respective access provider sites 25 and 35. Reference sign 60 denotes an IP based network via which a connection to a service provider can be established, for example the Internet. At Service Provider Sites 45, 55, mobility layer network portions, such as Home

Agents HA1 40 and HA2 50 are provided. It is to be noted that the Service Provider Sites may comprise several other entities, such as an AAA (authentication, authorization, accounting) entity, an application server and the like, which are known to those skilled in the art. In FIG. 4, for illustrating the respective sites where the elements involved in the signalling are located, boxes are included by dotted lines which show the elements located in the access provider site and the service provider site.

It is assumed that the user terminal 10 has been connected during a previous session to HA1 40 via the AGW1 20. The terminal then moves to a new location as shown by the arrow on the left side of FIG. 1. The following steps according to the mechanism to select the suitable access layer termination node are described in connection with FIG. 4.

Basically, in the procedure shown in FIG. 4, in first steps, i.e. steps M2 to M5, a home agent is assigned for the user terminal. Then, in following steps, i.e. steps M6 to M14, it is illustrated how the mechanism to select an access layer termination node according to the present example is used to select a suitable access layer network portion or access layer termination node by passing information between the user terminal 10 and the access gateways 20, 30 and the mobility anchor point (home agent 40, 50) on the mobility layer and by utilizing this information to control the access layer.

In step M1, the user terminal 10 connects to the AGW1 20, which is, for example, a PDG. The connection procedure to the AGW1 20 can be done according to known procedures so that a description thereof is omitted here. Then, a mobile IP registration request comprising, for example, a network access identifier (NAI) including user ID is sent from the user terminal 10 to a default home agent of the service provider site (step M2). The user ID may be derived from the NAI (if present) or by using the Home Address (HoA) of the mobile node. In the present case, it is assumed that the NAI is used to carry the user ID information. Furthermore, in the present case, it is assumed that there was no ongoing mobile IP session, so that this request M2 is sent to the default HA. The user terminal 10 can also send a localized information list comprising location information as described above in connection with this step M2.

The default HA sends in step M3 an authentication request (for example a Radius auth. req.) to an AAA entity or server (not shown in FIG. 1) with the user ID and IP address where the mobile IP request was sent from (i.e. the Care-of Address (CoA)). The AAA entity or server, in response to the authentication request, assigns a home agent for this session. On the basis of various parameters received, for example, in the authentication request, the AAA server assigns this session to the home agent HA2 50. It is to be noted that the current AGW1 20 (PDG) is not the optimum access layer termination node or access gateway for this session. The result of the assignment in the AAA server is sent to the default HA (requesting node) by means of a Radius access accept message (step M4).

After having recognized the message from the AAA server, the default HA requests the user terminal 10 to connect to home agent HA2 50. This request is transmitted by means of sending a MIP redirect message (step M5) to the user terminal 10 indicating the redirection to the HA2 50.

The user terminal 10 now sends in step M6 a new MIP registration request to the HA2 50 indicated in the MIP redirect message. Similar to the first MIP registration request (step M2), the user terminal 10 includes NAI and also localized information list comprising location information. The HA2 50 receives the registration request and replies to the user terminal 10 in step M7 by sending a connection parameter comprising information, such as addresses, for preferred connections. Since the HA2 50 is administered by a service provider and not by an access provider, in the present example, the list may include mainly guidance such as preferred access technologies and for example a location if a single access provider is used. Alternatively, it may also include a list of FQDNs for various access providers and access technologies. The message comprising the connection parameter list is transmitted by means of a MIP registration reply to the user terminal in step M7 via the hitherto access layer network portion or access gateway AGW1 20. This AGW1 20 intercepts the MIP message and supplements the list in step M8 with refined additional information or access termination recommendations, such as a list of preferred addresses available at the access provider site, so that the MIP registration reply now comprises the connection parameter list of the mobility layer network portion and the access layer network portion.

Then, in step M9, the AGW1 20 (e.g a PDG) forwards the MIP registration message together with the information to the user terminal 10. For the sake of simplicity, in FIG. 4, there is not shown a whole list but only just the address of the preferred AGW2 30 (i.e. IP address2, Wireless APN1).

The user terminal 10 notices that it does not yet have connection to the correct AGW (i.e. AGW2) and establishes in step M10 an IPSecure tunnel to the AGW2 (the AGW2 may be, for example, another PDG in the present case). It is to be noted that in case the HA2 sent also a list of preferred addresses, the user terminal 10 first checks that the access provider that has sent the (refined) address list is actually the preferred operator indicated in the list sent by the service provider.

Then, in step M11, the user terminal sends a MIP registration request to the HA2 50 to register the new CoA along with the location information. The HA2 50 replies upon a successful registration in step M12. The HA2 50 can also include again connection parameter list, for example an updated list comprising other addresses, into the reply message. Alternatively, in case there is no change, the HA2 50 does not include a list in the reply. If no further list is sent to the user terminal 10, the processing for the user terminal 10 is facilitated. In the example shown in FIG. 4, it is however assumed that a corresponding updated list is sent. However, in case there is no change, the user terminal 10 notices at this point that it already has a connection to the correct (preferred) access provider, so that no further action is necessary.

Similar to the above described case, the AGW2 30, via which the MIP registration reply is sent, intercepts the MIP registration reply message and supplements a list of preferred addresses to the MIP registration reply (step M13). Then, the AGW2 30 forwards the MIP reply message to the user terminal 10 (step M14). Again, not the whole list is shown in FIG. 4 but just the AGW2 (PDG) address. When receiving the message, the user terminal examines the list and notices that it already has a connection to the right PDG, so no further action is necessary. Then in step M15, the subscriber can access the services through the AGW2 30 as the access layer network portion and the HA2 50 as the mobility layer network portion.

Thus, an optimum connection path can be established by using the mechanism for selecting the access layer termination node described above.

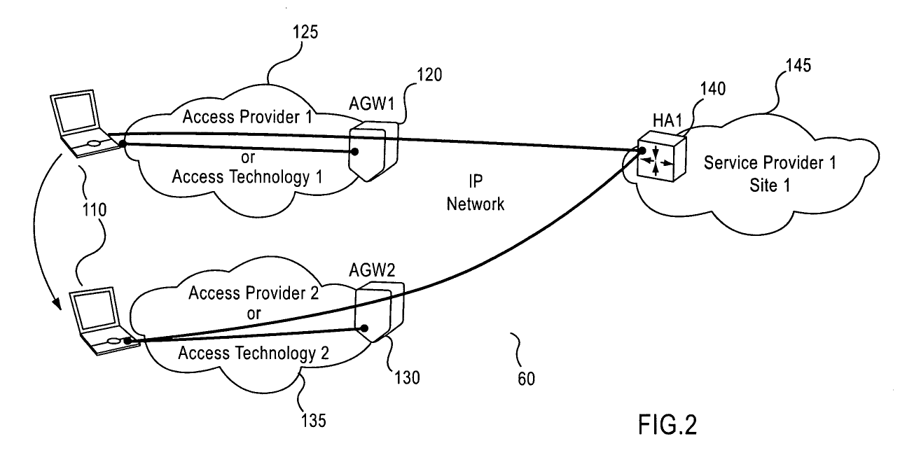

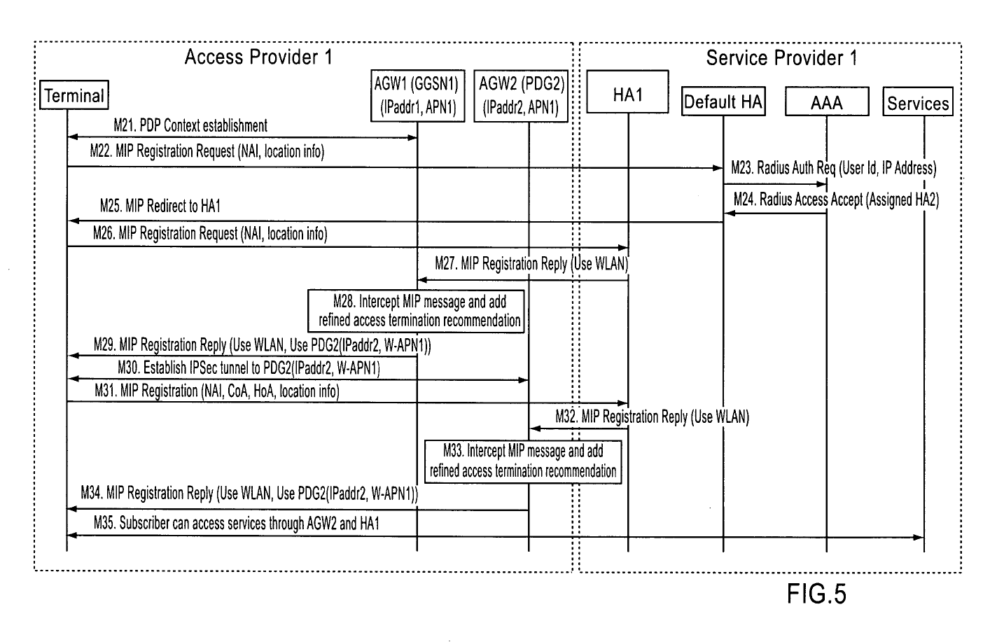

Next, a second example of the embodiment for the mechanism to select an access layer termination node for a communication connection of a user terminal in a multi-access network is described in connection with FIGS. 2 and 5.

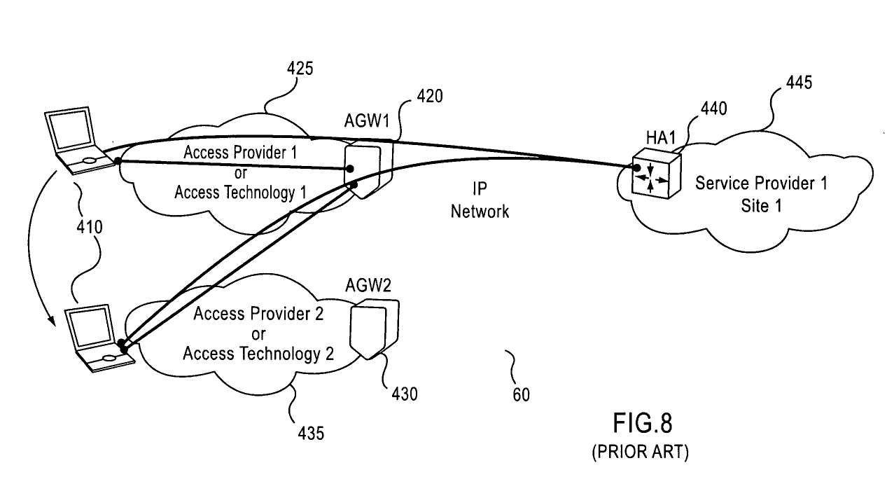

FIG. 2 shows a network architecture and FIG. 5 shows a signaling diagram illustrating an application of the mechanism to select an access layer termination node. The network architecture according to FIG. 2 is similar to that shown in FIG. 8. In FIG. 2, reference sign 110 denotes a mobile node or user terminal. The user terminal 110 may be a single-access or preferably a multi-access terminal. Reference signs 120 and 130 denote access gateways, such as a PDG, a GGSN or the like, which represent an access layer network portion or access termination node for a connection of the user terminal 110 via respective access provider sites 125 and 135. Reference sign 60 denotes an IP based network via which a connection to a service provider can be established, for example the Internet. At a Service Provider Site 145, a mobility layer network portion, such as a Home Agent HA1 140 is provided. It is to be noted that the Service Provider Site may comprise several other entities, such as an AAA (authentication, authorization, accounting) entity, an application server and the like, which are known to those skilled in the art. In FIG. 5, for illustrating the respective sites where the elements involved in the signalling are located, boxes are included by dotted lines which show the elements located in the access provider site and the service provider site.

Basically, in the procedure shown in FIG. 5, in first steps, i.e. steps M22 to M25, a home agent is assigned for the user terminal. Then, in following steps, i.e. steps M26 to M34, it is illustrated how the mechanism to select an access layer termination node according to the present example is used to select a suitable access layer network portion or access layer termination node by passing information between the user terminal 110 and the access gateways 120, 130 and the mobility anchor point (home agent 140) on the mobility layer and by utilizing this information to control the access layer.

In step M21, the user terminal 110 connects to the AGW1 120 (such as a GGSN) as normally. The connection procedure to the AGW1 120 can be done according to known procedures so that a description thereof is omitted here. Then, a mobile IP registration request comprising, for example, a network access identifier (NAI) including user ID is sent from the user terminal 10 to a default home agent of the service provider site (step M22). In the present case, it is assumed that there was no ongoing mobile IP session, so that this request M2 is sent to the default HA. The user terminal 10 can also send a localized information list comprising location information as described above in connection with this step M22. In the present example, the user terminal 110 may inform about the availability of a WLAN access in the present location (via AGW2 130, for example).

The default HA sends in step M23 an authentication request (for example a Radius auth. req.) to an AAA entity or server (not shown in FIG. 2) with the user ID and IP address where the mobile IP request was sent from (i.e. the Care-of Address (CoA)). The AAA entity or server, in response to the authentication request, assigns a home agent for this session. On the basis of various parameters received, for example, in the authentication request, the AAA server assigns this session to the home agent HA1 140. The result of the assignment in the AAA server is sent to the default HA (requesting node) by means of a Radius access accept message (step M24).

After having recognized the message from the AAA server, the default HA requests the user terminal 110 to connect to home agent HA1 140. This request is transmitted by means of sending a MIP redirect message (step M25) to the user terminal 110 indicating the redirection to the HA1 140.

The user terminal 110 now sends in step M26 a new MIP registration request to the HA1 140 indicated in the MIP redirect message. Similar to the first MIP registration request (step M22), the user terminal 110 includes NAI and also localized information list comprising location information. In this localized information list, it is also indicated that a WLAN access is available at the current location.

The HA1 140 receives the registration request and replies to the user terminal 110 in step M27 by sending a connection parameter comprising information, such as addresses, for preferred connections. Since the HA1 140 is administered by a service provider and not by an access provider, in the present example, the list may include mainly guidance such as preferred access technologies and for example a location if a single access provider is used. Alternatively, it may also include a list of FQDNs for various access providers and access technologies. In the present example, it is determined by the mobility layer network portion, i.e. the home agent HA1 140, that the preferred access technology is WLAN access, so that a corresponding indication is included in the prioritized list as a highest priority.

The message comprising the connection parameter list is transmitted by means of a MIP registration reply to the user terminal 110 in step M27 via the hitherto access layer network portion or access gateway AGW1 120. This AGW1 120 (i.e. the GGSN) intercepts the MIP message and supplements the list in step M28 with refined additional information or access termination recommendations, such as a list of preferred addresses available at the access provider site, so that the MIP registration reply now comprises the connection parameter list of the mobility layer network portion and the access layer network portion. It is to be noted that this interception and supplement procedure by the AGW1 120 is optional in the present example.

Then, in step M29, the AGW1 120 (e.g. the GGSN) forwards the MIP registration message together with the information to the user terminal 110. For the sake of simplicity, in FIG. 5, there is not shown a whole list but only just the address of the preferred AGW2 130 (i.e. IP address2, Wireless APN1).

The user terminal 110 notices that it does not yet have connection to the correct AGW (i.e. AGW2 being a PDG for a WLAN connection) and has to change the access technology, so that is establishes in step M30 an IPSecure tunnel to the AGW2 130. It is to be noted that in case the AGW1 120 has included a refined list for the connection parameter list and the HA1 140 sent also a list of preferred addresses, the user terminal 110 first checks that the access provider that has sent the (refined) address list is actually the preferred operator indicated in the list sent by the service provider.

Then, in step M31, the user terminal 110 sends a MIP registration request to the HA1 140 to register the new CoA along with the location information. The HA1 140 replies upon a successful registration in step M32. The HA1 140 can also include again a connection parameter list, for example an updated list comprising other addresses, into the reply message. Alternatively, in case there is no change, the HA1 140 does not include a list in the reply. If no further list is sent to the user terminal 110, the processing for the user terminal 110 is facilitated. In the example shown in FIG. 5, it is however assumed that a corresponding updated list is sent. However, in case there is no change, the user terminal 110 notices at this point that it already has a connection to the correct (preferred) access provider (AGW2), so that no further action is necessary.

The AGW2 130, via which the MIP registration reply is sent, intercepts the MIP registration reply message and supplements a list of preferred addresses to the MIP registration reply (step M33). Then, the AGW2 130 forwards the MIP reply message to the user terminal 110 (step M34). Again, not the whole list is shown in FIG. 5 but just the AGW2 (PDG) address. When receiving the message, the user terminal 110 examines the list and notices that it already has a connection to the right AGW, i.e. the PDG, so no further action is necessary. Then in step M35, the subscriber can access the services through the AGW2 130 as the access layer network portion and the HA1 140 as the mobility layer network portion.

Thus, an optimum connection path can be established by using the mechanism for selecting the access layer termination node described above.

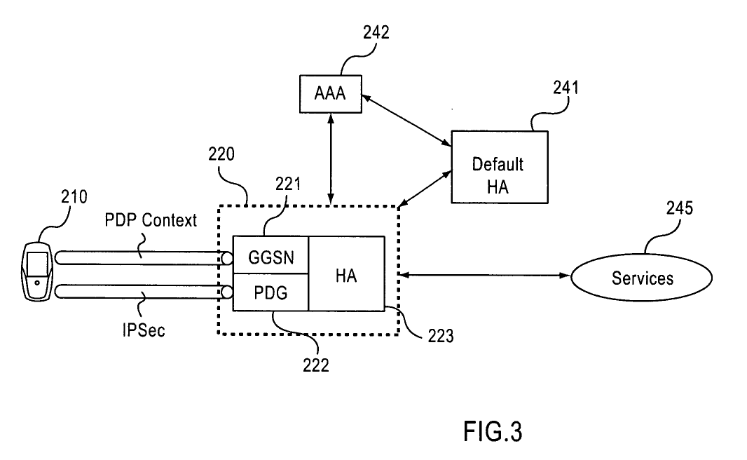

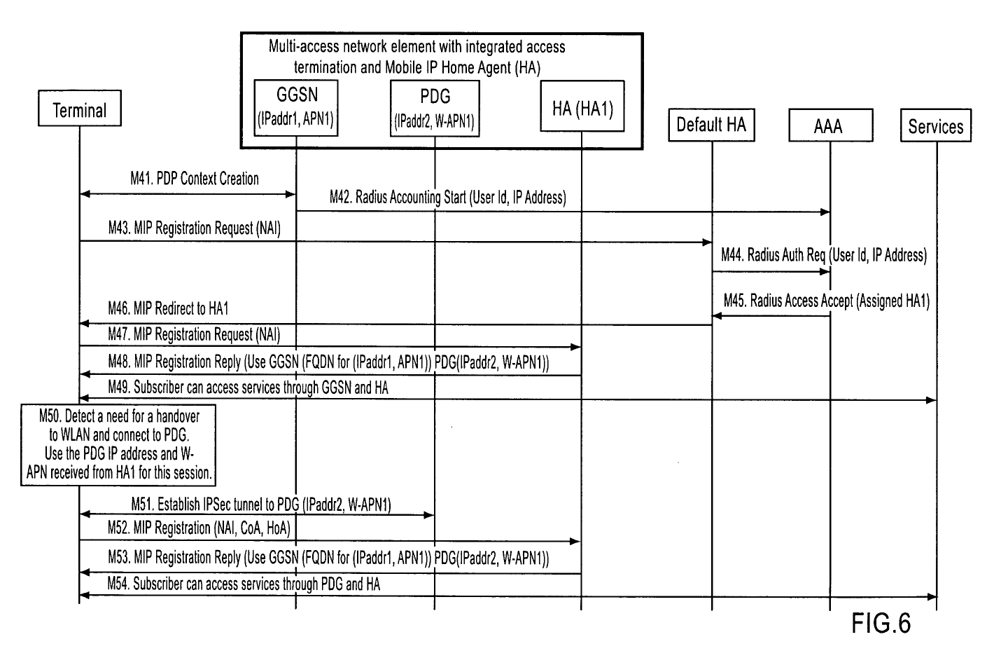

In the following, a third example of an embodiment for the mechanism to select an access layer termination node for a communication connection of a user terminal in a multi-access network is described in connection with FIGS. 3 and 6.

FIG. 3 shows a network architecture and FIG. 6 shows a signaling diagram illustrating an application of the mechanism to select an access layer termination node.

In FIG. 3, reference sign 210 denotes a mobile node or user terminal. The user terminal 210 may be a multi-access terminal providing access by means of different access technologies, such as GPRS based and WLAN capabilities. Reference signs 220 denotes a multi-access network element that has integrated several access termination portions such as a GGSN portion 221 and a PDP portion 222, and a mobile IP home agent portion 223. In this example the GGSN portion 221 for a GPRS access and the PDG portion 222 for a WLAN access are provided. The multi-access user terminal 210 can connect to the GGSN portion 221 via a Packet Data Protocol (PDP) context signalling and to the PDP portion 222 via a IP Secure channel. By means of the this multi-access network element 220, it is possible to provide access to services 245 either through GPRS or WLAN with seamless service continuity. The multi-access network element 220 is also connected to a default home agent 241 and to an AAA server 242. The default home agent 241 and the AAA server 242 are also connected with each other.

In FIG. 6, the elements included in the multi-access network element 220 are combined by means of a dotted box.

In the present third example, a case is described where the mechanism for selecting the suitable access layer termination node is used in a handover from, for example, GPRS to WLAN. As a matter of course, the mechanism can also be applied to cases where a change from another access technology to also another access technology occurs. It is to be noted that in the example shown in FIG. 3, although the used access technology changes, still access is all the time through same physical network element providing access termination for both GPRS access and WLAN access as well as a mobile IP home agent for mobility support. Because both the access termination (access layer network portion) and the home agent (mobility layer network portion) are implemented in the same element, the home agent functionality can utilize all the information available at the access termination functionality. This arrangement preferably makes the system more robust and minimizes latencies during the handovers.

Basically, in the procedure shown in FIG. 6, in first steps, i.e. steps 42 to M46, a home agent is assigned for the user terminal. Then, in following steps, i.e. steps M47 to M53, it is illustrated how the mechanism to select an access layer termination node according to the present example is used to keep the access termination and home agent within the same network element during a handover between different access technologies. A handover from WLAN to GPRS could be done in the same way utilizing the information received from the home agent during the first mobile IP registration.

In step M41, the user terminal 210 connects to the GGSN portion 221 of the multi-access network element 220. The connection procedure to the GGSN portion 221 can be done according to known procedures in a GPRS network so that a description thereof is omitted here. It is to be noted that a special APN can be used to direct traffic to a GGSN with an integrated HA if also legacy GGSNs are used.

The GGSN portion 221 sends in step M42 a Radius accounting Start message to the AAA server 242 which includes the IP address allocated to the user terminal 210 and a user ID.

Furthermore, in step M43, the user terminal 210 send a mobile IP registration request to the default HA 241. In the present case, it is assumed that there was no ongoing MIP session, so that this request is sent to the default HA 241. Then, in step M44, the default HA 241 sends an authentication request, for example a Radius Auth. Req. message, to the AAA server 242 with the user ID and IP address where the MIP request was sent from (i.e. the Care-of Address (CoA) of the user terminal 210).

The AAA server 242 assigns the HA portion 223 of the multi-access network element 220 for this session. Since the GGSN portion 221 where the request came from has an integrated HA (i.e. the HA portion 223), the AAA server 242 assigns this session to it (i.e. the HA 223). The result of the assignment in the AAA server 242 is sent to the default HA 241 by means of a Radius access accept message (step M45).

After having recognized the message from the AAA server 242, the default HA 241 requests the user terminal 210 to connect to HA portion 223. This request is transmitted by means of sending a MIP redirect message (step M46) to the user terminal 210 indicating the redirection to the HA 223.

The user terminal 210 now sends in step M47 a new MIP registration request to the HA 223 indicated in the MIP redirect message. The HA 223 replies in step M48 to the user terminal 210 by adding a connection parameter list comprising preferred connection points for both GPRS access and WLAN access. This list includes also information on how to connect to the GGSN portion 221 (for GPRS) as well as the PDG portion 222 (for WLAN). In this case the information includes IP addresses and access point names. It is to be noted that the FQDN used to resolve the IP address of the GGSN 221 by a (not shown) SGSN must uniquely identify the GGSN.

Thus, the subscriber can now access the services 245 through the GGSN portion 221 and the HA 223 by using GPRS access (step M49).

In step M50, the user terminal 210 detects a need for executing a handover from GPRS to WLAN. The reason for the need of a handover may be, for example, deteriorated quality of the GPRS connection, traffic load or the like. However, for a WLAN access, a connection to the PDG portion 222 is needed. Now, the user terminal 210 can use the information of the connection parameter list (addresses and the like) for this session received in step M48.

Hence, the user terminal 210 establishes in step M51 an IPSecure tunnel to the PDG portion 222 in the multi-access network element 220 where also the HA portion 223 is located, which is handling this ongoing mobile IP session. A new IP address is allocated for the user terminal by the PDG portion 222. This will be the new CoA.

The user terminal sends in step M52 a MIP registration request to the HA 223 to register the new CoA. The HA 223 replies upon a successful registration in step M53 with a MIP registration reply message. The HA can also include an updated connection parameter list comprising addresses into the reply message, for example an updated list comprising other addresses. Alternatively, in case there is no change, the HA 223 does not include a list in the reply. If no further list is sent to the user terminal 210, the processing for the user terminal 210 is facilitated. In the example shown in FIG. 6, it is however assumed that a corresponding updated list is sent. However, in case there is no change, the user terminal 210 notices at this point that it already has a connection to the correct (preferred) access portion, i.e. the PDG portion, so that no further action is necessary.

The subscriber 210 can now access the services 245 through the PDG portion 222 and the HA 223. As an option, the user terminal can now tear down the PDP context to the GGSN portion 221.

Thus, an optimum connection path can be established by using the mechanism for selecting the access layer termination node described above.

As described above, there is proposed a mechanism to select an access layer termination node for a communication connection of a user terminal in a multi-access network, in which a connection parameter list is transmitted in a mobile IP registration procedure from a mobility layer network portion to a user terminal. The connection parameter list comprises prioritized information on connection parameters of an access layer. The prioritized information is then used for selecting an access layer network portion when establishing a connection between the user terminal and a network comprising the access layer network portion.

It should be understood that the above description and accompanying figures are merely intended to illustrate the present invention by way of example only. The preferred embodiments of the present invention may thus vary within the scope of the attached claims.

1. A method comprising:
transmitting in a mobile internet protocol (IP) registration procedure a connection parameter list from a mobility layer network portion to a user terminal, wherein the connection parameter list comprises prioritized information on connection parameters of an access layer; and
using the prioritized information for selecting an access layer network portion when establishing a connection between the user terminal and a network comprising the access layer network portion.

2. The method according to claim 1, further comprising:
creating the connection parameter list in the mobility layer network portion.

3. The method according to claim 1, further comprising:
including in the connection parameter list at least one of the following information
information on an access technology and/or a type of network element of the access layer network portion;
information on a network address of the access layer network portion;
information on an access point name required for a connection to the access layer network portion;
an identifier of an operator administering the connection parameter list.

4. The method according to claim 2, further comprising:
transmitting in the mobile IP registration procedure a localized information list from the user terminal to the mobility layer network portion, wherein the localized information list comprises information detected at a location of the user terminal; and
using the information of the localized information list for creating the connection parameter list.

5. The method according to claim 4, further comprising:
including into the localized information list at least one of the following information
information on an access technology available at the location of the user terminal;
information on networks visible to the user terminal at the location;
location information of the user terminal.

6. The method according to claim 1, further comprising:
updating the connection parameter list at each mobile IP registration procedure before transmitting the connection parameter list to the user terminal.

7. The method according to claim 6, further comprising:
when an updated connection parameter list comprising different prioritized information is received, using the different prioritized information for selecting an access layer network portion for establishing a connection between the user terminal and the network; and
disconnecting the connection with the hitherto access layer network portion.

8. The method according to claim 4, further comprising:
updating the localized information list at each mobile IP registration procedure before transmitting the connection parameter list to the mobility layer network portion.

9. The method according to claim 1, further comprising:
intercepting the transmission of the connection parameter list by a network element between the mobility layer network portion and the user terminal;
supplementing the prioritized information with refined information on the access layer available at the network element intercepting the transmission; and
forwarding the connection parameter list together with the supplemented refined information to the user terminal.

10. The method according to claim 9, wherein the network element intercepting the transmission of the connection parameter list comprises the access layer network portion.

11. The method according to claim 1, wherein the selecting of the access layer network portion comprises at least one of selecting another access network element and selecting another access technology.

12. The method according to claim 1, wherein the access layer network portion comprises an access gateway element of a network and the mobility layer network portion comprises a home agent.

13. An apparatus configured to:
act as a mobility layer network element for a communication connection of a user terminal via a network; and
transmit in a mobile internet protocol (IP) registration procedure a connection parameter list to the user terminal, wherein the connection parameter list comprises prioritized information on connection parameters of an access layer, the prioritized information being usable to select an access layer network portion when establishing a connection between the user terminal and a network comprising the access layer network portion.

14. The apparatus according to claim 13, the apparatus being further configured to create the connection parameter list.

15. The apparatus according to claim 13, the apparatus being further configured to include into the connection parameter list at least one of the following information:
information on an access technology and/or a type of network element of the access layer network portion;
information on a network address of the access layer network portion;
information on an access point name required for a connection to the access layer network portion;
an identifier of an operator administering the connection parameter list.

16. The apparatus according to claim 14, the apparatus being further configured to:
receive in the mobile IP registration procedure a localized information list from the user terminal, wherein the localized information list comprises information detected at the location of the user terminal; and
use the information of the localized information list for creating the connection parameter list.

17. The apparatus according to claim 16, wherein the localized information list comprises at least one of the following information:
information on an access technology available at the location of the user terminal;
information on networks visible to the user terminal at the location;
location information of the user terminal.

18. The apparatus according to claim 13, the apparatus being further configured to:
update the connection parameter list at each mobile IP registration procedure before transmitting the connection parameter list to the user terminal.

19. The apparatus according to claim 13, wherein the access layer network portion comprises an access gateway element of a network and the mobility layer network portion comprises a home agent.

20. An apparatus configured to:
act as a user terminal capable of communicating in a network;
receive in a mobile internet protocol (IP) registration procedure a connection parameter list from a mobility layer network portion, wherein the connection parameter list comprises prioritized information on connection parameters of an access layer; and
use the prioritized information to select an access layer network portion when establishing a connection between the user terminal and a network comprising the access layer network portion.

21. The apparatus according to claim 20, wherein the connection parameter list comprises at least one of the following information:
information on an access technology and/or a type of network element of the access layer network portion;
information on a network address of the access layer network portion;
information on an access point name required for a connection to the access layer network portion;
an identifier of an operator administering the connection parameter list.

22. The apparatus according to claim 20, the apparatus being further configured to:
detect information at a location of the apparatus and create a localized information list based on the detected information; and
transmit in the mobile IP registration procedure the localized information list to the mobility layer network portion, wherein the information of the localized information list is usable to create the connection parameter list.

23. The apparatus according to claim 22, the apparatus being further configured to include into the localized information list at least one of the following information:
information on an access technology available at the location of the user terminal;
information on networks visible to the user terminal at the location;
location information of the user terminal.

24. The apparatus according to claim 20, the apparatus being further configured to:
receive an updated connection parameter list at each mobile IP registration procedure.

25. The apparatus according to claim 24, the apparatus being further configured, when an updated connection parameter list comprising different prioritized information is received, to use the different prioritized information to select an access layer network portion for establishing a connection between the user terminal and the network, and to disconnect the connection with the hitherto access layer network portion.

26. The apparatus according to claim 22, the apparatus being further configured to:
update the localized information list at each mobile IP registration procedure before transmitting the connection parameter list to the mobility layer network portion.

27. The apparatus according to claim 20, the apparatus being further configured to:
receive a connection parameter list from a network element between the mobility layer network portion and the user terminal, the network element having intercepted the transmission of the connection parameter list and supplemented the prioritized information with refined information on the access layer available at the network element intercepting the transmission; and
use the information in the connection parameter list and the supplemented refined information to select an access layer network portion.

28. The apparatus according to claim 20, the apparatus being further configured to select, when selecting the access layer network portion, at least one of another access network element and another access technology.

29. The apparatus according to claim 20, wherein the access layer network portion comprises an access gateway element of a network and the mobility layer network portion comprises a home agent.

30. An apparatus configured to:
act as an access layer network portion usable for a connection of a user terminal to a network;
intercept a transmission of a connection parameter list from a mobility layer network portion of the network and the user terminal, wherein the connection parameter list comprises prioritized information on connection parameters of an access layer usable for selecting an access layer network portion when establishing a connection between the user terminal and a network comprising the access layer network portion;
supplement the prioritized information with refined information on the access layer available at the apparatus intercepting the transmission; and
forward the connection parameter list together with the supplemented refined information to the user terminal.

31. The apparatus according to claim 30, wherein the connection parameter list and the supplemented refined information comprise at least one of the following information:
information on an access technology and/or a type of network element of the access layer network portion;
information on a network address of the access layer network portion;
information on an access point name required for a connection to the access layer network portion;
an identifier of an operator administering the connection parameter list.

32. The apparatus according to claim 30, wherein the access layer network portion comprises an access gateway element of a network and the mobility layer network portion comprises a home agent.

33. A computer program product embodied on a computer-readable medium, comprising software code portions for making, when said product is run on a computer, said computer to function as a mobility layer network element for a communication connection of a user terminal via a network, wherein the computer program product is configured to execute:
transmitting in a mobile internet protocol (IP) registration procedure a connection parameter list to the user terminal, wherein the connection parameter list comprises prioritized information on connection parameters of an access layer, the prioritized information being usable for selecting an access layer network portion when establishing a connection between the user terminal and a network comprising the access layer network portion.

34. A computer program product embodied on a computer-readable medium, comprising software code portions for making, when said product is run on the computer, said computer to function as a user terminal capable of communicating in a network, wherein the computer program product is configured to execute:
receiving in a mobile IP registration procedure a connection parameter list from a mobility layer network portion, wherein the connection parameter list comprises prioritized information on connection parameters of an access layer;
using the prioritized information for selecting an access layer network portion when establishing a connection between the user terminal and a network comprising the access layer network portion.

35. A computer program product embodied on a computer-readable medium, comprising software code portions for making, when said product is run on the computer, said computer to function as an access layer network portion usable for a connection of a user terminal to a network, wherein the computer program product is configured to execute:
intercepting a transmission of a connection parameter list from a mobility layer network portion of the network and a user terminal, wherein the connection parameter list comprises prioritized information on connection parameters of an access layer usable for selecting an access layer network portion when establishing a connection between the user terminal and a network comprising the access layer network portion;
supplementing the prioritized information with refined information on the access layer available at the apparatus intercepting the transmission; and
forwarding the connection parameter list together with the supplemented refined information to the user terminal.

36. A system comprising:
a plurality of access layer network portions usable for connecting a user terminal to a network;
at least one mobility layer network portion; and
a user terminal,
wherein the at least one mobility layer network portion is configured to transmit in a mobile internet protocol (IP) registration procedure a connection parameter list to the user terminal, wherein the connection parameter list comprises prioritized information on connection parameters of an access layer, and
the user terminal is configured to use the prioritized information for selecting an access layer network portion from the plurality of access layer network portions when establishing a connection between the user terminal and the network comprising the access layer network portion.

37. The system according to claim 36, wherein the mobility layer network portion is further configured to:
create the connection parameter list in the mobility layer network portion.

38. The system according to claim 37, wherein
the user terminal is configured to transmit in the mobile IP registration procedure a localized information list from to the mobility layer network portion, wherein the localized information list comprises information detected at the location of the user terminal, and
the mobility layer network portion is configured to use the information of the localized information list for creating the connection parameter list.

39. The system according to claim 36, wherein the mobility layer network portion is configured to update the connection parameter list at each mobile IP registration procedure before transmitting the connection parameter list to the user terminal.

40. The system according to claim 39, wherein
when an updated connection parameter list comprising different prioritized information is received, the user terminal is configured to
use the different prioritized information for selecting an access layer network portion for establishing a connection between the user terminal and the network, and
disconnect the connection with the hitherto access layer network portion.

41. The system according to claim 38, wherein the user terminal is configured to:
update the localized information list at each mobile IP registration procedure before transmitting the connection parameter list to the mobility layer network portion.

42. The system according to claim 36, wherein the access layer network portion is configured to:
intercept the transmission of the connection parameter list;
supplement the prioritized information with refined information on the access layer; and
forward the connection parameter list together with the supplemented refined information to the user terminal.

43. The system according to claim 36, wherein the user terminal is configured to select, when selecting the access layer network portion, at least one of another access network element and another access technology.

44. The system according to claim 36, wherein the access layer network portion comprises an access gateway element of a network and the mobility layer network portion comprises a home agent.

45. An apparatus comprising:
means for receiving in a mobile IP registration procedure a connection parameter list from a mobility layer network portion, wherein the connection parameter list comprises prioritized information on connection parameters of an access layer; and
means for using the prioritized information for selecting an access layer network portion when establishing a connection between a user terminal and a network comprising the access layer network portion.
